(19) United States
(12) Patent Application Publication
(10) Pub. No.: US 2013/0133634 A1
(43) Pub. Date: May 30, 2013

(54) CONTROLLER FOR INTERNAL COMBUSTION ENGINE

(71) Applicant: DENSO CORPORATION, Kariya-city (JP)

(72) Inventors: Shinichi Hiraoka, Chiryu-city (JP); Hideaki Ichihara, Obu-city (JP)

(73) Assignee: DENSO CORPORATION, Kariya-city (JP)

(21) Appl. No.: 13/685,929

(22) Filed: Nov. 27, 2012

(30) Foreign Application Priority Data
Nov. 28, 2011 (JP) 2011-258664

(51) Int. Cl. F02M 25/07; F02B 47/08

(52) U.S. Cl. CPC F02M 25/0771; F02B 47/08
USPC 123/568.16

(57) ABSTRACT

While an engine is at idling state with an EGR valve fully closed, an EGRLQ is detected or estimated. When the EGRLQ exceeds a specified threshold, a target intake manifold pressure is established so that the EGRLQ becomes less than the specified value and an IAFRI-control is executed so that the intake manifold pressure becomes the target pressure. An intake air flow rate QIN can be increased and a differential pressure DP between upstream and downstream of the EGR valve 31 is reduced to effectively decrease an EGR rate. An ignition timing is retarded according to an increase in intake air flow rate QIN due to the IAFRI-control. An increase in torque (increase in intake air flow rate) due to the IAFRI-control is canceled by an increase in a required torque (increase in required intake air flow rate) due to a retard of the ignition timing.

### CROSS-REFERENCE TO RELATED APPLICATION

This application is based on Japanese Patent Application No. 2011-258664 filed on Nov. 28, 2011, the disclosure of which is incorporated herein by reference.

### TECHNICAL FIELD

The present disclosure relates to a controller for an internal combustion engine provided with an EGR valve which controls an exhaust gas quantity recirculating into an intake pipe.

### BACKGROUND

In order to reduce exhaust emission, an internal combustion engine is provided with an exhaust gas recirculation (EGR) apparatus. The EGR apparatus has an EGR valve disposed in an EGR passage. The EGR valve adjusts quantity of EGR gas recirculating into an intake pipe through the EGR passage. The quantity of EGR gas is referred to as EGR gas quantity, hereinafter.

However, according the EGR gas quantity increases, the intake air (fresh air) quantity intaken into a cylinder decreases, so that a combustion condition of air-fuel mixture may deteriorate.

JP-U-553-32243A shows an ignition control system in which an ignition timing is advanced when an EGR apparatus is operated or when an engine is at idling in order to improve a fuel combustion in an internal combustion engine.

When an EGR valve is worn away or a foreign object is engaged between a valve body and a valve seat of the EGR valve, a valve clearance between the valve body and the valve seat is enlarged at a full-close position, which may increase a leakage quantity of the EGR gas flowing into an intake passage when the EGR valve is fully closed. Especially, when the intake air flow rate is relatively small at idling state, the EGR gas quantity becomes excessive due to the EGR gas leakage, which may deteriorate the fuel combustion condition.

When the EGR gas leakage occurs, it is likely that the intake air flow rate is decreased relative to a required output of the engine and the fuel combustion condition is more deteriorated due to the EGR gas leakage even though the ignition timing is advanced like the above ignition control system.

### SUMMARY

It is an object of the present disclosure to provide a controller for an internal combustion engine, which is able to restrict a deterioration in fuel combustion condition due to an EGR gas leakage.

According to the present disclosure, a controller is applied for an internal combustion engine provided with an EGR valve which adjusts an exhaust gas quantity recirculating from an exhaust passage into an intake passage. The controller includes: an leakage determining portion which detects or estimates a leakage information representing an EGR gas quantity flowing into the intake passage while the EGR valve is fully closed; and an IAFRI-control portion which executes an IAFRI-control in which an intake air flow rate is increased so that an intake air pressure in the intake passage becomes a target intake air pressure in accordance with the leakage information.

The IAFRI-control portion executes the IAFRI-control in which an intake air flow rate is increased so that an intake air pressure in the intake passage becomes a target intake air pressure in accordance with the leakage information, whereby the intake air flow rate can be increased and a differential pressure between upstream and downstream of the EGR valve 31 can be reduced. Thus, the EGR gas leakage quantity can be reduced and an EGR rate can be decreased effectively. A fuel combustion condition can be improved.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a schematic view of an engine control system according to a first embodiment of the present invention;

FIGS. 2A and 2B are graphs for explaining a method for establishing a target intake manifold pressure;

FIGS. 3A to 3E are graphs for explaining a method for detecting or estimating an EGR gas leakage quantity;

FIG. 4 is a flow chart showing a processing of an IAFRI-control routine according to the first embodiment;

FIG. 5 is a flowchart showing a processing for detecting an EGR gas leakage quantity;

FIG. 6 is a flowchart showing a processing for estimating an EGR gas leakage quantity;

FIGS. 7A to 7E are graphs showing each parameter of the IAFRI-control;

FIG. 8 is a time chart showing the IAFRI-control according to the first embodiment;

FIG. 9 is a chart showing an improvement in fuel combustion by an intake air quantity increase and an ignition timing retard;

FIG. 10 is a chart showing an improvement in fuel combustion by an intake air quantity increase and an engine speed increase;

FIG. 11 is a flow chart showing a processing of an IAFRI-control routine according to a second embodiment; and

FIG. 12 is a flow chart showing a processing of an IAFRI-control routine according to a third embodiment.

### DETAILED DESCRIPTION

Embodiments of the present invention will be described, hereinafter.

### First Embodiment

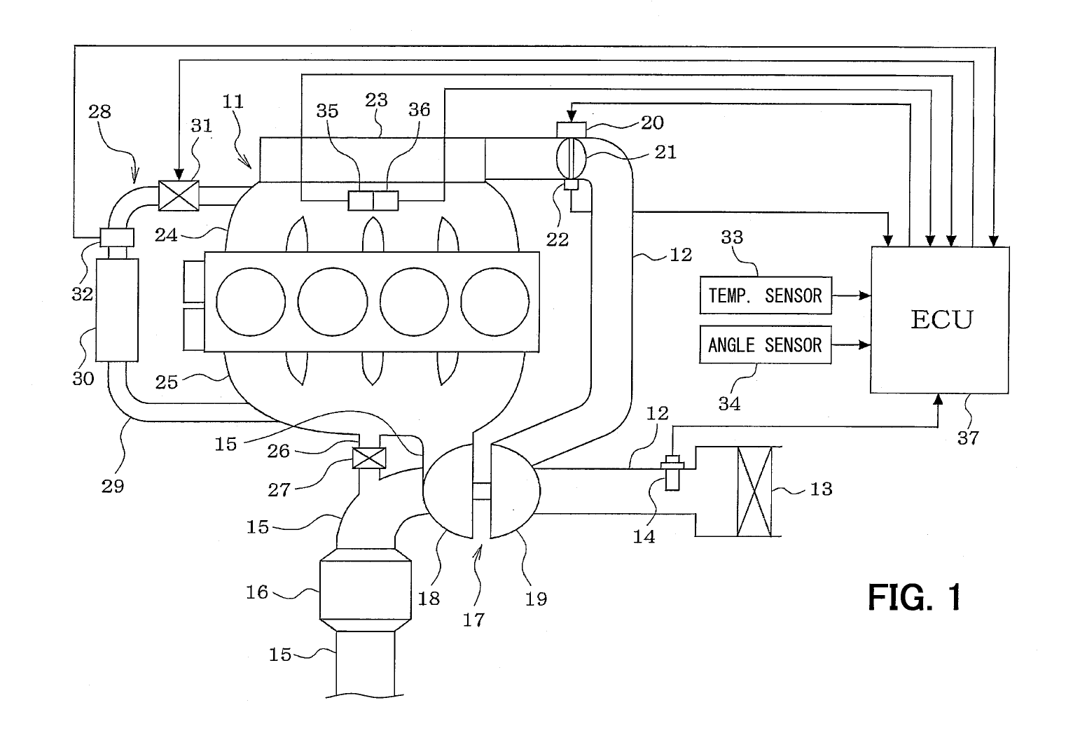

Referring to FIGS. 1 to 10, a first embodiment will be described hereinafter. An engine control system is schematically explained based on FIG. 1. An air cleaner 13 is arranged upstream of an intake pipe 12 (intake passage) of an internal combustion engine 11. An airflow meter 14 detecting an intake air flow rate QIN is provided downstream of the air cleaner 13. An exhaust pipe 15 (exhaust passage) of the engine 11 is provided with a three-way catalyst 16 which reduces CO, HC, NOx, and the like contained in exhaust gas.

The engine 11 is provided with a turbocharger 17. The turbocharger 17 includes an exhaust gas turbine 18 arranged upstream of the catalyst 16 in the exhaust pipe 15 and a compressor 19 arranged downstream of the airflow meter 14 in the intake pipe 12. This turbocharger 17 has well known configuration which supercharges the intake air into the combustion chamber.

A throttle valve 21 driven by a DC-motor 20 and a throttle position sensor 22 detecting a throttle position (throttle opening degree) are provided downstream of the compressor 19.

An intercooler (not shown) and a surge tank 23 is provided downstream of the throttle valve 21. The intercooler may be arranged upstream of the surge tank 23 and the throttle valve 21. An intake manifold 24 (intake passage) which introduces air into each cylinder of the engine 11 is provided downstream of the surge tank 23, and a fuel injector (not shown) which injects fuel is provided for each cylinder. A spark plug (not shown) is mounted on a cylinder head of the engine 11 corresponding to each cylinder to ignite air-fuel mixture in each cylinder.

An exhaust manifold 25 (exhaust passage) is connected to each exhaust port of the cylinder. A confluent portion of the exhaust manifold 25 is connected to the exhaust pipe 15 upstream of the exhaust gas turbine 18. An exhaust bypass passage 26 bypassing the exhaust gas turbine 18 is connected to the exhaust pipe 15. A waste gate valve (WGV) 27 is disposed in the exhaust bypass passage 26 to open/close the exhaust bypass passage 26.

The engine 11 is provided with an EGR apparatus 28 which recirculates a part of exhaust gas flowing through an exhaust passage upstream of the catalyst 16 into an intake passage downstream of the throttle valve 21. The EGR apparatus 28 has an EGR pipe 29 connecting the exhaust passage downstream of the catalyst 16 and the intake passage downstream of the throttle valve 21. An EGR cooler 30 for cooling the EGR gas and an EGR valve 31 for adjusting an exhaust gas recirculation quantity (EGR gas quantity) are provided in the EGR pipe 29. The EGR valve 31 is a butterfly valve. An opening degree of the EGR valve 31 is adjusted by a motor (not shown), such as a DC motor and a stepping motor. Moreover, a gas-temperature sensor 32 is provided in the EGR pipe 29 downstream of the EGR cooler 30 for detecting EGR gas temperature in the EGR pipe 29.

Further, the engine 11 is provided with a coolant temperature sensor 33 detecting coolant temperature and a crank angle sensor 34 outputting a pulse signal every when the crank shaft (not shown) rotates a specified crank angle. Based on the output signal of the crank angle sensor 34, a crank angle and an engine speed are detected. In the intake passage including the surge tank 23 and the intake manifold 24, an EGR gas sensor 35, such as an air fuel ratio sensor and an oxygen sensor, which detects EGR gas concentration and an intake pressure sensor 36 which detects intake manifold pressure (intake pressure in the surge tank 23 or the intake manifold 24) are arranged.

The outputs of the above sensors are transmitted to an electronic control unit (ECU) 37. The ECU 37 includes a microcomputer which executes an engine control program stored in a Read Only Memory (ROM) to control a fuel injection quantity, an ignition timing, a throttle position (intake air flow rate) and the like.

The ECU 37 computes a target EGR quantity or a target EGR rate according to an engine driving condition (engine speed, engine load and the like). The ECU 37 controls the opening degree of the EGR valve 31 to obtain the target EGR quantity or the target EGR rate. For example, when the engine is at idling state, the EGR valve 31 is brought into a full-close position.

When an EGR valve 31 is worn away or a foreign object is engaged between a valve body and a valve seat of the EGR valve 31, a valve clearance between the valve body and the valve seat is enlarged at a full-close position, which may increase a leakage quantity of the EGR gas flowing into the intake passage when the EGR valve 31 is fully closed. Especially, when the intake air flow rate QIN is relatively small at idling state, the EGR gas quantity becomes excessive due to the EGR gas leakage, which may deteriorate the fuel combustion condition.

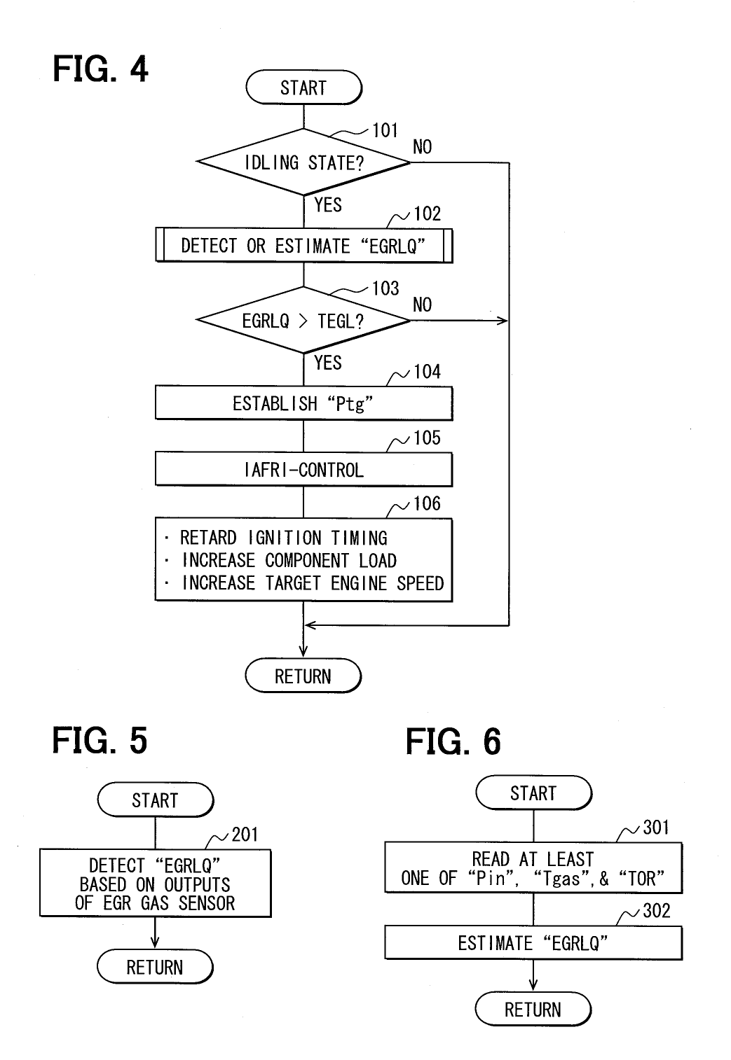

According to the first embodiment, the ECU 37 executes each of routines shown in FIGS. 4 to 11. While the engine is at idling state with the EGR valve 31 fully closed, the ECU 37 detects or estimates the EGR gas leakage quantity EGRLQ. When the EGRLQ exceeds a specified threshold TEGL, the ECU 37 executes an intake-air-flow-rate increasing control (IAFRI-control) in which the intake air flow rate QIN is increased so that the intake manifold pressure (intake air pressure) agrees with the target intake manifold pressure (target intake air pressure).

By executing the IAFRI-control, the intake air flow rate QIN can be increased and a differential pressure DP between upstream and downstream of the EGR valve 31 can be reduced. Thus, the EGRLQ can be reduced and an EGR rate (=EGR gas quantity in a cylinder/Total gas quantity in a cylinder) can be decreased effectively.

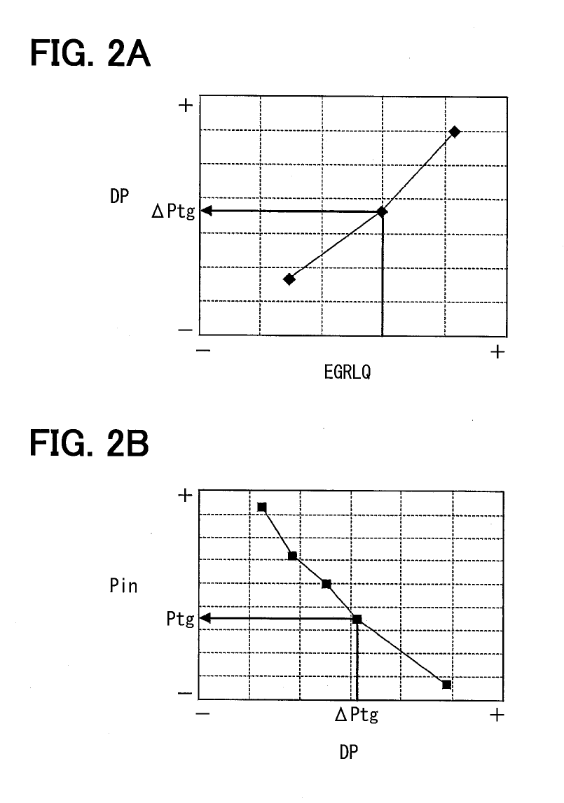

Generally, as shown in FIG. 2A, as the differential pressure DP between upstream and downstream of the EGR valve 31 is larger, the EGRLQ becomes larger. According to the present embodiment, a target differential pressure ΔPtg is computed so that the EGRLQ becomes lower than or equal to a specified value. As shown in FIG. 2B, a target intake manifold pressure Ptg is computed so that the differential pressure DP becomes the target differential pressure ΔPtg, whereby the EGRLQ becomes lower than or equal to the specified value.

Specifically, the EGRLQ is detected based on the outputs of the EGR gas sensor 35. Thus, the EGRLQ can be detected with high accuracy.

Alternatively, the EGRLQ can be estimated based on at least one of the intake manifold pressure detected by the pressure sensor 36, the gas temperature detected by the temperature sensor 32 and a driving torque of the EGR valve 31.

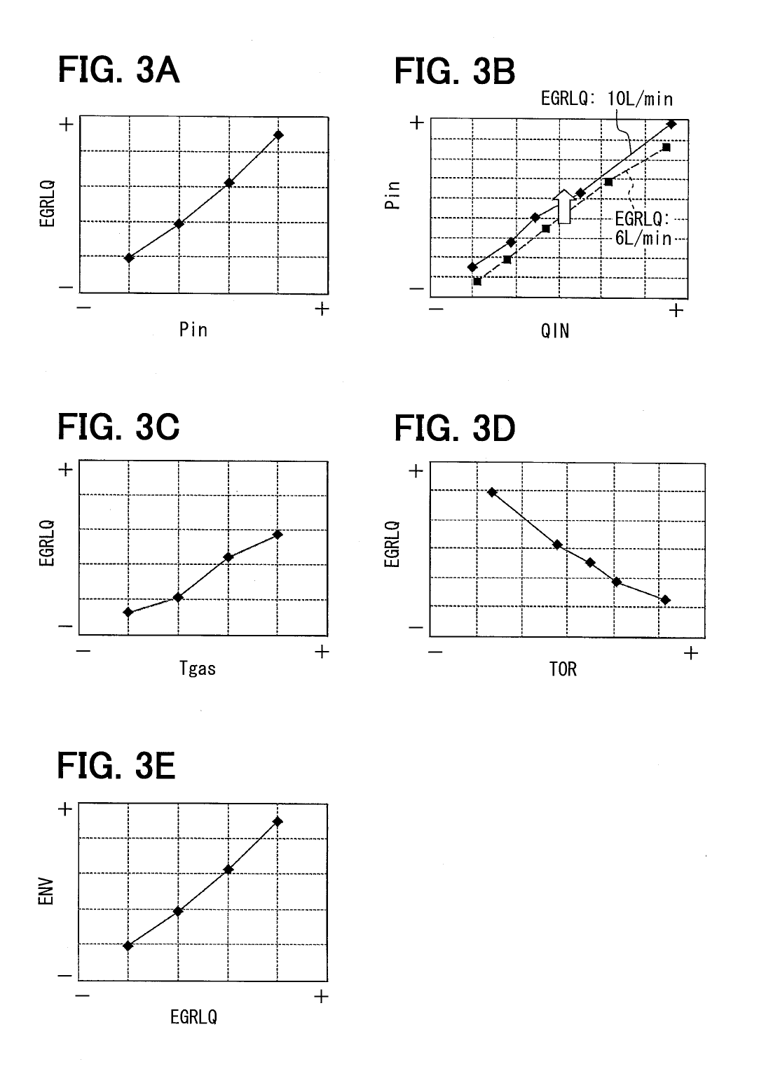

As shown in FIGS. 3A and 3B, as the EGRLQ increases, the intake manifold pressure Pin becomes higher. Also, as shown in FIG. 3C, as the EGRLQ increases, the gas temperature downstream of the EGR cooler 30 (Tgas) becomes higher. As shown in FIG. 3D, as the EGRLQ increases, the driving torque of the EGR valve 31 (TOR) around the full close position becomes smaller. When the EGR valve 31 is positioned around the full closed position, the motor current and an angular speed vary. Based on the motor current and the angular speed, the TOR can be computed.

As shown in FIGS. 3A to 3D, each of Pin, Tgas and TOR is a parameter accurately indicating the EGRLQ. Based on at least one of these, the EGRLQ can be estimated with high accuracy. In this case, the EGR gas sensor 35 is not always necessary for detecting the EGRLQ.

According to the present embodiment, when executing the IAFRI-control, the ignition timing is retarded according to an increase in intake air flow rate QIN due to the IAFRI-control. An increase in torque (increase in intake air flow rate) due to the IAFRI-control is canceled by an increase in a required torque (increase in required intake air flow rate) due to a retard of the ignition timing.

Alternatively, the load of component driven by an engine (for example, load of an alternator) is increased according to the increase in intake air flow rate QIN due to the IAFRI-control. The increase in torque (increase in intake air flow rate) due to the IAFRI-control may be canceled by the increase in a required torque (increase in required intake air flow rate) due to the increase in load of component driven by the engine.

Alternatively, a target engine speed (target idle speed) is increased according to the increase in intake air flow rate QIN due to the IAFRI-control. The increase in torque (increase in intake air flow rate) due to the IAFRI-control may be canceled by the increase in the required torque (increase in required intake air flow rate) due to the increase in engine speed.

The above IAFRI-control is executed by the ECU 37 according to each routine shown in FIGS. 4 and 5 (or FIGS. 4 and 6). The process of each routine will be described hereinafter.

### [IAFRI-Control Routine]

An IAFRI-control routine shown in FIG. 4 is executed at a specified cycle while the ECU 37 is ON. The IAFRI-control routine corresponds to an intake-air-flow-rate increasing control portion. In step 101, the computer determines whether the engine 11 is at idling state (low-load state). When the answer is NO, the procedure ends.

Meanwhile, when the answer is YES in step 101, the procedure proceeds to step 102 in which an EGRLQ detection routine shown in FIG. 5 is executed to detect the EGRLQ. Alternatively, the EGRLQ may be estimated by executing an EGRLQ estimation routine shown in FIG. 6.

Then, the procedure proceeds to step 103 in which the ECU 37 determines whether the EGRLQ exceeds the specified threshold TEGL. When the answer is NO, the ECU 37 determines that there is no adverse effect due to the EGR gas leakage. Then, the procedure ends without executing the IAFRI-control.

Meanwhile, when the answer is YES in step 103, the procedure proceeds to step 104 in which the target intake manifold pressure Ptg is established. In this case, the target differential pressure ΔPtg is computed so that the EGRLQ becomes lower than or equal to the specified value. The target intake manifold pressure Ptg is computed so that the differential pressure DP between upstream and downstream of the EGR valve 31 becomes the target differential pressure ΔPtg, whereby the EGRLQ becomes lower than or equal to the specified value.

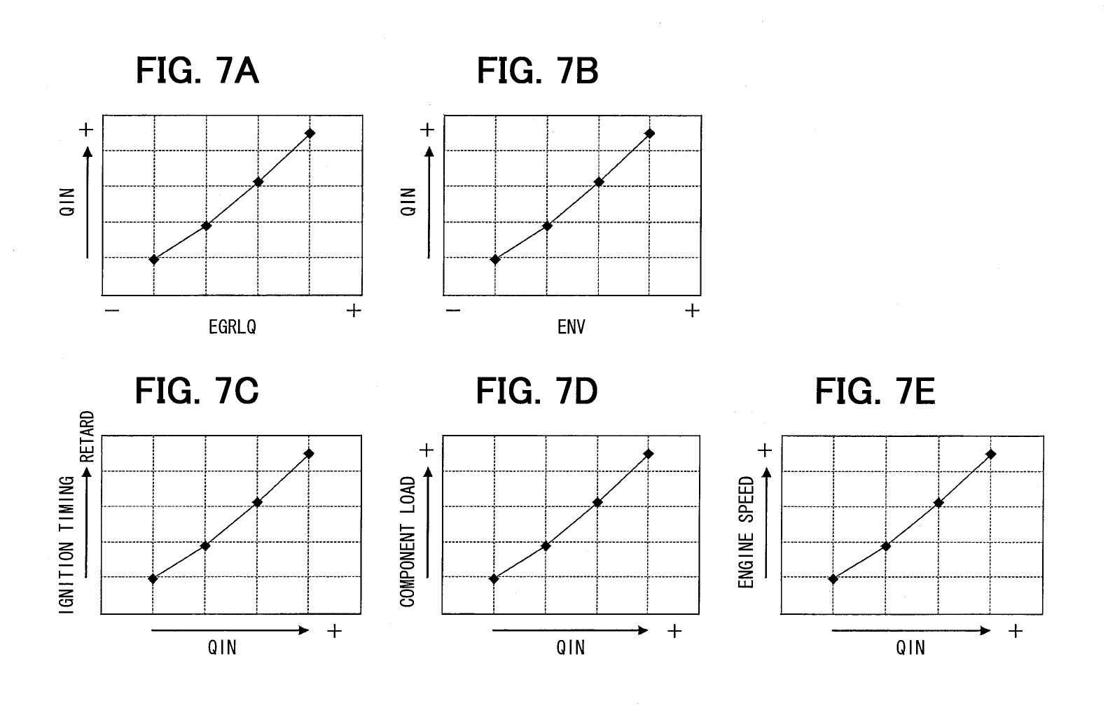

Then, the procedure proceeds to step 105 in which the IAFRI-control is executed so that the intake manifold pressure Pin becomes the target pressure Ptg. Thereby, as shown in FIG. 7A, the intake air flow rate QIN is increased according to the EGRLQ and the differential pressure DP between upstream and downstream of the EGR valve 31 is decreased, so that the EGRLQ is decreased.

Then, the procedure proceeds to step 106 in which the ignition timing is retarded according to an increase in intake air flow rate QIN due to the IAFRI-control, as shown in FIG. 7C. Alternatively, the load of component driven by an engine (for example, load of an alternator) may be increased according to the increase in intake air flow rate QIN due to the IAFRI-control, as shown in FIG. 7D. Alternatively, a target engine speed (target idle speed) may be increased according to the increase in intake air flow rate QIN due to the IAFRI-control, as shown in FIG. 7E.

Two or three of the ignition time retard, the component load increase and the target engine speed increase may be executed at the same time.

### [EGRLQ Detection Routine]

An EGRLQ detection routine shown in FIG. 5 is a sub-routine executed in step 102 of the IAFRI-control routine shown in FIG. 4. The EGRLQ detection routine corresponds to a leakage determining portion. In step 201, the EGRLQ is detected based on the outputs of the EGR gas sensor 35. The EGRLQ can be detected with high accuracy.

### [EGRLQ Estimation Routine]

Instead of the above EGRLQ detection routine, an EGRLQ estimation routine shown in FIG. 6 may be executed. In this case, the EGRLQ estimation routine corresponds to the leakage determining portion. In step 301, at least one of Pin, Tgas and TOR is read.

Then, the procedure proceeds to step 302 in which the EGRLQ is computed (estimated) based on at least one of Pin, Tgas and TOR by using of a map or a formula.

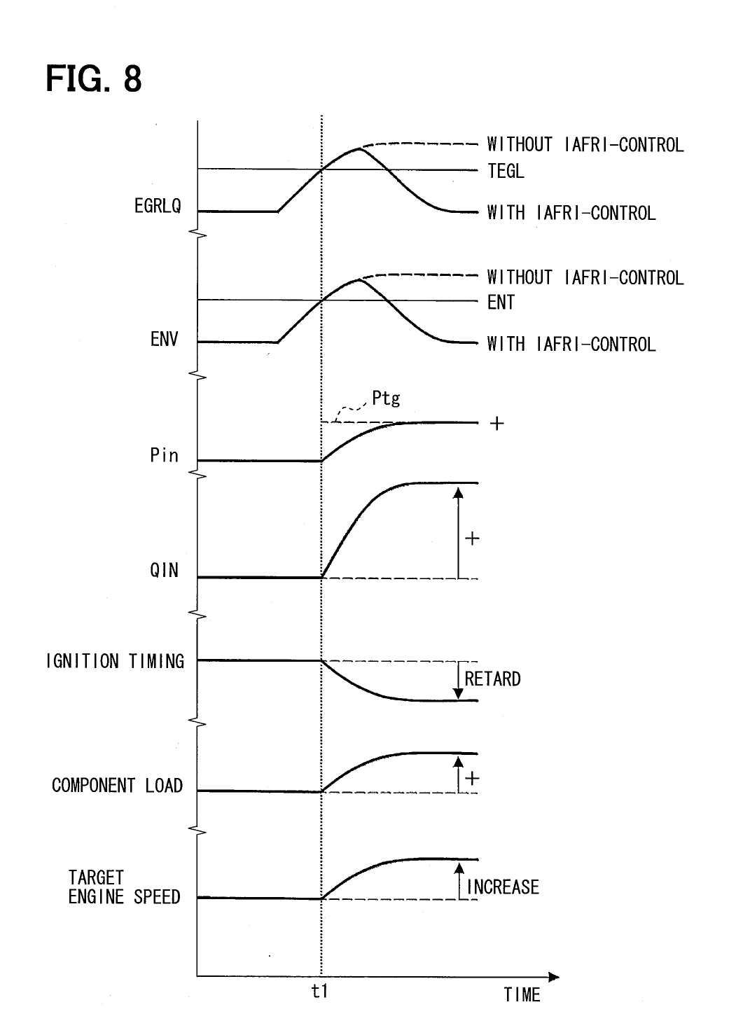

Referring to a time chart shown in FIG. 8, the IAFRI-control will be described more specifically, hereinafter.

While the engine is at idling state with the EGR valve 31 fully closed, the EGRLQ is detected or estimated. When the EGRLQ exceeds the specified threshold TEGL at a time t1, the target pressure Ptg is computed so that the differential pressure DP between upstream and downstream of the EGR valve 31 becomes the target differential pressure ΔPtg. The target intake manifold pressure Ptg is established so that the EGRLQ becomes less than the specified value. The IAFRI-control is executed so that the intake manifold pressure Pin becomes the target pressure Ptg. The intake air flow rate QIN can be increased and the differential pressure DP between upstream and downstream of the EGR valve 31 can be reduced. Thus, the EGR rate can be decreased effectively and the fuel combustion condition can be improved.

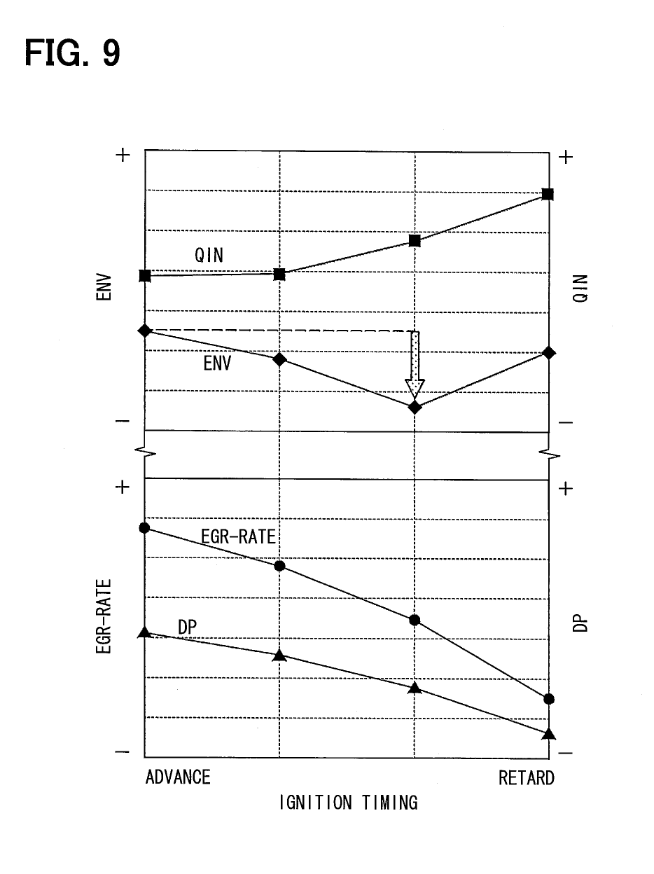

According to the present embodiment, when executing the IAFRI-control, the ignition timing is retarded according to an increase in intake air flow rate QIN due to the IAFRI-control. An increase in torque (increase in intake air flow rate) due to the IAFRI-control can be canceled by an increase in a required torque (increase in required intake air flow rate) due to a retard of the ignition timing. It can be restricted that unpleasant torque fluctuation is generated and the engine speed fluctuates, as shown in FIG. 9.

Alternatively, the load of component driven by an engine (for example, load of an alternator) may be increased according to the increase in intake air flow rate QIN due to the IAFRI-control. Thereby, an increase in torque (increase in intake air flow rate) due to the IAFRI-control may be canceled by the increase in a required torque (increase in required intake air flow rate) due to the increase in load of component driven by the engine. It can be restricted that unpleasant torque fluctuation is generated and the engine speed fluctuates, as shown in FIG. 9.

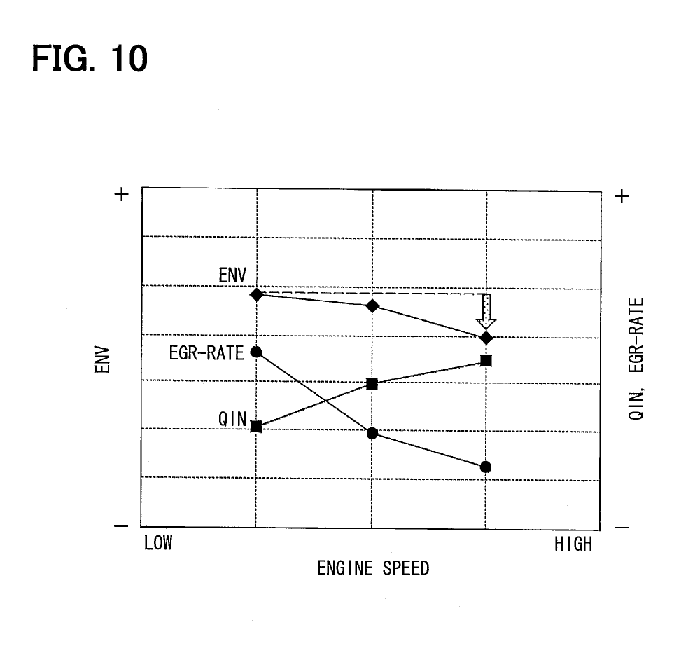

Alternatively, a target engine speed (target idle speed) may be increased according to the increase in intake air flow rate QIN due to the IAFRI-control. Thereby, the increase in torque (increase in intake air flow rate) due to the IAFRI-control may be canceled by the increase in the required torque (increase in required intake air flow rate) due to the increase in engine speed. It can be restricted that unpleasant torque fluctuation is generated and the engine speed fluctuates, as shown in FIG. 10.

### Second Embodiment

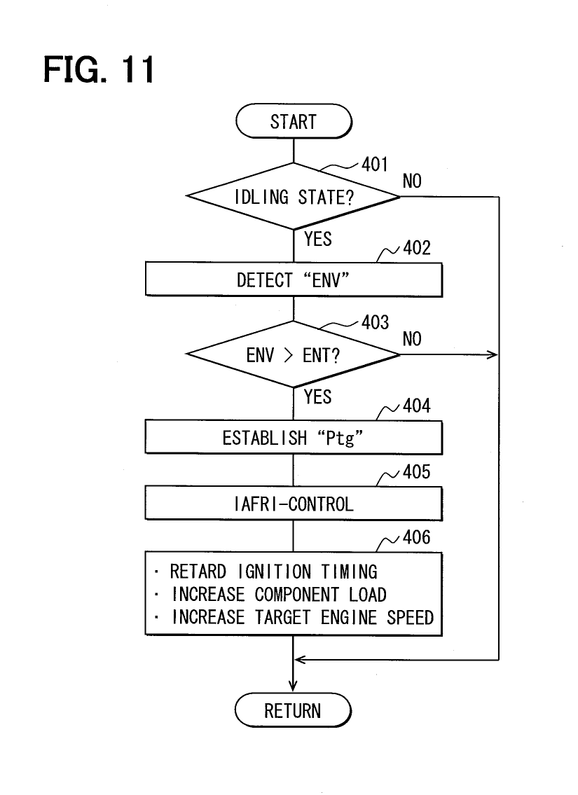

Referring to FIG. 11, a second embodiment will be described hereinafter. In the second embodiment, the same parts and components as those in the first embodiment are indicated with the same reference numerals and the same descriptions will not be reiterated.

According to the second embodiment, the ECU 37 executes an IAFRI-control routine shown in FIG. 11 in order to detect an engine speed variation (standard variation in engine speed) as the EGRLQ information. When the engine speed variation ENV exceeds a specified value ENT, the IAFRI-control is executed so that the intake manifold pressure Pin becomes the target pressure Ptg. As the EGRLQ is more increased, the engine speed variation ENV becomes larger as shown in FIG. 3E. The engine speed variation is a parameter which accurately indicates the EGRLQ.

In step 401, the ECU 37 determines whether the engine 11 is at idling state (low-load state). When the answer is NO, the procedure ends. When the answer is YES, the procedure proceeds to step 402 in which the engine speed variation ENV is computed based on the engine speed detected by the crank angle sensor 34. The process in step 402 corresponds to the leakage determining portion.

Then, the procedure proceeds to step 403 in which the ECU 37 determines whether the engine speed variation ENV exceeds the specified value ENT. When the answer is NO, the ECU 37 determines that there is no adverse effect due to the EGR gas leakage. Then, the procedure ends without executing the IAFRI-control.

When the answer is YES in step 403, the ECU 37 determines that the EGRLQ exceeds the specified threshold TEGL. Then, the procedure proceeds to step 404 in which the target intake manifold pressure Ptg is computed so that the differential pressure DP between upstream and downstream of the EGR valve 31 becomes the target differential pressure ΔPtg, whereby the EGRLQ becomes lower than or equal to the specified value.

Then, the procedure proceeds to step 405 in which the IAFRI-control is executed so that the intake manifold pressure Pin becomes the target pressure Ptg. Then, the procedure proceeds to step 406 in which the ignition timing is retarded according to an increase in intake air flow rate QIN due to the IAFRI-control. Alternatively, the load of component driven by an engine (for example, load of an alternator) may be increased according to the increase in intake air flow rate QIN due to the IAFRI-control. Alternatively, a target engine speed (target idle speed) may be increased according to the increase in intake air flow rate QIN due to the IAFRI-control.

Two or three of the ignition time retard, the component load increase and the target engine speed increase may be executed at the same time.

According to the above described second embodiment, when the engine speed variation ENV exceeds the specified value ENT, the IAFRI-control is executed so that the intake manifold pressure Pin becomes the target pressure Ptg. Thus, the same advantages as the first embodiment can be obtained. The EGR gas sensor 35 is not always necessary for detecting the EGRLQ.

### Third Embodiment

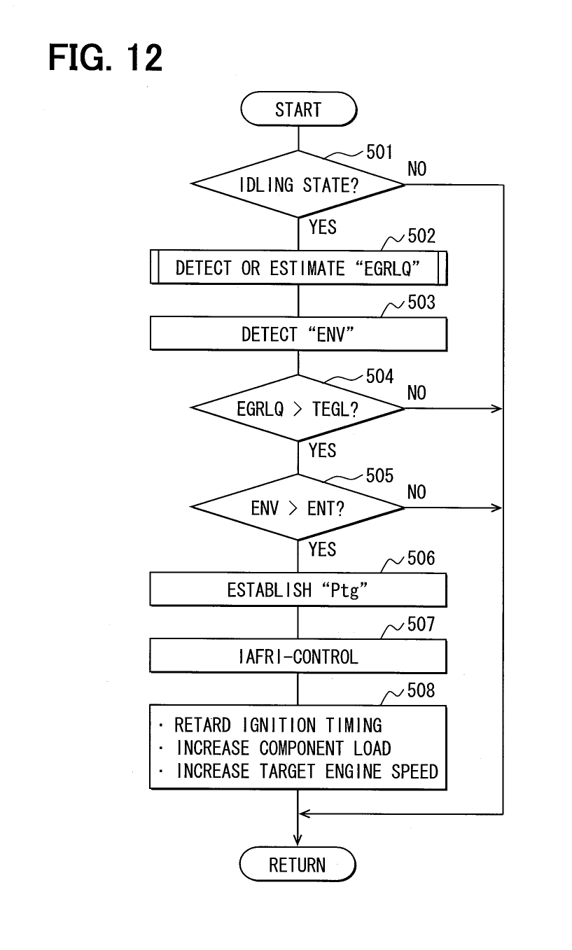

Referring to FIG. 12, a third embodiment will be described hereinafter. In the third embodiment, the same parts and components as those in the first and the second embodiment are indicated with the same reference numerals and the same descriptions will not be reiterated.

According to the third embodiment, the ECU 37 executes an IAFRI-control routine shown in FIG. 12 in order to detect or estimate the EGRLQ and to detect the engine speed variation ENV. When the EGRLQ exceeds the specified threshold TEGL and the engine speed variation ENV exceeds the specified value ENT, the IAFRI-control is executed so that the intake manifold pressure Pin becomes the target pressure Ptg.

In step 501, the computer determines whether the engine 11 is at idling state (low-load state). When the answer is NO, the procedure ends. When the answer is YES in step 501, the procedure proceeds to step 502 in which an EGRLQ detection routine shown in FIG. 5 is executed to detect the EGRLQ. Alternatively, the EGRLQ may be estimated by executing an EGRLQ estimation routine shown in FIG. 6.

Then, the procedure proceeds to step 503 in which the engine speed variation ENV is computed based on the engine speed detected by the crank angle sensor 34.

Then, the procedure proceeds to step 504 in which the ECU 37 determines whether the EGRLQ exceeds the specified threshold TEGL. When the ECU 37 determines that the EGRLQ exceeds the specified threshold TEGL, the procedure proceeds to step 505 in which the ECU 37 determines whether the engine speed variation ENV exceeds the specified value ENT.

When the answer is NO in step 504 or step 505, the ECU 37 determines that there is no adverse effect due to the EGR gas leakage. Then, the procedure ends without executing the IAFRI-control.

When the answer is YES in step 504 and step 505, the procedure proceeds to step 506 in which the target intake manifold pressure Ptg is computed so that the differential pressure DP between upstream and downstream of the EGR valve 31 becomes the target differential pressure ΔPtg, whereby the EGRLQ becomes lower than or equal to the specified value.

Then, the procedure proceeds to step 507 in which the IAFRI-control is executed so that the intake manifold pressure Pin becomes the target pressure Ptg. Then, the procedure proceeds to step 508 in which the ignition timing is retarded according to an increase in intake air flow rate QIN due to the IAFRI-control. Alternatively, the load of component driven by an engine (for example, load of an alternator) may be increased according to the increase in intake air flow rate QIN due to the IAFRI-control. Alternatively, a target engine speed (target idle speed) may be increased according to the increase in intake air flow rate QIN due to the IAFRI-control.

Two or three of the ignition time retard, the component load increase and the target engine speed increase may be executed at the same time.

According to the above described third embodiment, the IAFRI-control is executed only when both the EGRLQ and the engine speed variation ENV exceed the specified value. Thus, it can be avoided that the IAFRI-control is executed more than needed.

In the above first to third embodiments, the IAFRI-control is executed with the engine at idling state. However, the IAFRI-control can be executed when the engine is at other than idling stage.

Also, the present disclosure can be applied to an engine having no supercharger.

What is claimed is:

1. A controller for an internal combustion engine provided with an EGR valve which adjusts an exhaust gas quantity recirculating from an exhaust passage into an intake passage, the controller comprising:
a leakage determining portion which detects or estimates a leakage information representing an EGR gas quantity flowing into the intake passage while the EGR valve is fully closed; and
an IAFRI-control portion which executes an IAFRI-control in which an intake air flow rate is increased so that an intake air pressure in the intake passage becomes a target intake air pressure in accordance with the leakage information.

2. A controller for an internal combustion engine according to claim 1, wherein
the IAFRI-control portion executes the IAFRI-control when the leakage information exceeds a predetermined allowed value.

3. A controller for an internal combustion engine according to claim 1, wherein
when the IAFRI-control portion establishes the target intake air pressure, the IAFRI-control portion computes a target pressure of a differential pressure between upstream and downstream of the EGR valve so that the leakage information is not more than a specified value, and computes the target intake air pressure so that the differential pressure becomes the target pressure.

4. A controller for an internal combustion engine according to claim 1, further comprising:
a portion which retards an ignition timing according to an increase in intake air flow rate due to the IAFRI-control.

5. A controller for an internal combustion engine according to claim 1, further comprising:
a portion which increases a load of a component driven by the internal combustion engine according to an increase in intake air flow rate due to the IAFRI-control.

6. A controller for an internal combustion engine according to claim 1, further comprising:
a portion which increases a target engine speed of the internal combustion engine according to an increase in intake air flow rate due to the IAFRI-control.

7. A controller for an internal combustion engine according to claim 1, further comprising:
an EGR gas sensor which detects an EGR gas concentration in the intake passage, wherein
the leakage determining portion detects a leakage quantity of the EGR gas flowing into the intake passage based on an output of the EGR gas sensor.

8. A controller for an internal combustion engine according to claim 1, wherein
the leakage determining portion estimates a leakage quantity of the EGR gas flowing into the intake passage based on at least one of an intake air pressure in the intake passage, a gas temperature downstream of an EGR cooler which cools the EGR gas, and a driving torque of the EGR valve.

9. A controller for an internal combustion engine according to claim 1, wherein
the leakage determining portion detects a variation in speed of the internal combustion engine as the leakage information.
